(19) United States
(12) Patent Application Publication
(10) Pub. No.: US 2011/0202951 A1
(43) Pub. Date: Aug. 18, 2011

(54) MULTIMEDIA TERMINAL DEVICE AND OPERATING METHOD THEREOF, AND PERSONAL PORTABLE DEVICE FOR PROVIDING WIRED/WIRELESS RETRANSMISSION SERVICE

(75) Inventors: Do-Seob AHN, Daejeon (KR); Ho Jin LEE, Daejeon (KR); Hee Wook KIM, Daejeon (KR); Young Bo SAKONG, Daejeon (KR)

(73) Assignees: Electronics and Telecommunications Research Institute, Daejeon (KR); SOLETOP CO., LTD., Daejeon (KR)

(21) Appl. No.: 13/026,881

(22) Filed: Feb. 14, 2011

(30) Foreign Application Priority Data
Feb. 12, 2010 (KR) 10-2010-0013298
Sep. 10, 2010 (KR) 10-2010-0088722

(51) Int. Cl. H04N 7/173; H04N 7/16; H04N 5/445

(52) U.S. Cl. 725/25; 725/110; 725/40

(57) ABSTRACT

A personal portable terminal and an operating method of a multimedia terminal device are provided, and more particularly, a multimedia terminal device, an operating method of the multimedia terminal device, and a personal portable terminal are provided. The multimedia terminal device may receive bidirectional content and additional service information corresponding to the bidirectional content, may classify the received additional service information from the received bidirectional content, and may transmit the classified additional service information to a personal portable terminal that is registered in advance and that is connected wired or wirelessly to the multimedia terminal device.

### CROSS-REFERENCE TO RELATED APPLICATIONS

This application claims the benefit of Korean Patent Application No, 10-2010-0013298 and of Korean Patent Application No. 10-2010-0088722, respectively filed on Feb. 12, 2010 and Sep. 10, 2010, in the Korean Intellectual Property Office, the disclosures of which are incorporated herein by reference.

### BACKGROUND

1. Field of the Invention

The present invention relates to a multimedia terminal device, an operating method of the multimedia terminal device, and a personal portable terminal that may provide a wired/wireless retransmission service so that a personalized bidirectional content service may be effectively provided.

2. Description of the Related Art

As wideband media is widespread and a communication speed is improved, the Internet is emerging as new media enabling One Source Multi-Use (OSMU).

As an example of the OSMU, a large number of airwave Television (TV) channels and a large number of radio channels, as well as multimedia contents provided by Internet providers may be serviced via the Internet.

Demands for Internet broadcasting to provide OSMU services tend to increase, along with a rapid increase in population using the Internet.

In such an environment, an Internet Protocol Television (IPTV) based on an Internet Protocol (IP) may appear as a representative service.

The best feature of the IPTV is to provide a bidirectional TV broadcasting service via the ultrahigh speed Internet.

The IPTV may connect an Internet-connected content providing server and a display device via a Set-Top Box (STB), and may display, on the display device, bidirectional content provided by the content providing server, to provide a user with the bidirectional content. Here, the bidirectional content may include, for example, information content, moving image content, broadcasting content, and the like.

Services associated with bidirectional content using an IP network are being actively provided.

Since the IPTV enables a bidirectional service based on a user's request, compared with unilateral transmission of a conventional TV, it is possible to apply the IPTV in various ways.

When a user's request is received, an IPTV needs to provide a variety of additional service information. Here, the variety of additional service information may also be displayed on a display device on which bidirectional content is being currently displayed.

Accordingly, when a user requests additional service information and verifies the requested additional service information, the additional service information may cover a significant portion of a currently viewed screen, which may cause a reduction in a visible area of the display device.

Additionally, users may request their respective desired additional service information. However, since received additional service information is displayed on a screen viewed by several users, personal privacy may be invaded.

Furthermore, a number of channels of an IPTV may be increased due to necessity to provide high-quality content, and a great amount of information may be transmitted or received due to bidirectivity. Accordingly, a transmission bandwidth may be inevitably increased in size.

### SUMMARY

According to an aspect of the present invention, there is provided a multimedia terminal device including: a content receiver to receive bidirectional content, and additional service information corresponding to the bidirectional content; an additional service information classifier to classify the received additional service information from the received bidirectional content; and a transmission controller to transmit the classified additional service information to a personal portable terminal, registered in advance.

According to another aspect of the present invention, there is provided a personal portable terminal including: a registration request processor to request a multimedia terminal device to register the personal portable terminal, the multimedia terminal device receiving bidirectional content, and additional service information corresponding to the bidirectional content from a content providing server; an additional service information receiver to receive the additional service information from the multimedia terminal device when the personal portable terminal is registered in the multimedia terminal device; and a user interface to display the received additional service information.

According to still another aspect of the present invention, there is provided an operating method of a multimedia terminal device, the operating method including: receiving registration request information from a personal portable terminal requesting a registration; storing terminal identification information of the personal portable terminal requesting the registration; receiving bidirectional content and additional service information corresponding to the bidirectional content; classifying the received additional service information from the received bidirectional content; and transmitting the classified additional service information to the personal portable terminal requesting the registration, based on the stored terminal identification information.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a bidirectional content service system according to an embodiment of the present invention;

FIG. 2 is a block diagram illustrating a multimedia terminal device according to an embodiment of the present invention;

FIG. 3 is a block diagram illustrating a personal portable terminal according to an embodiment of the present invention; and

FIG. 4 is a flowchart illustrating an operating method of a multimedia terminal device according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

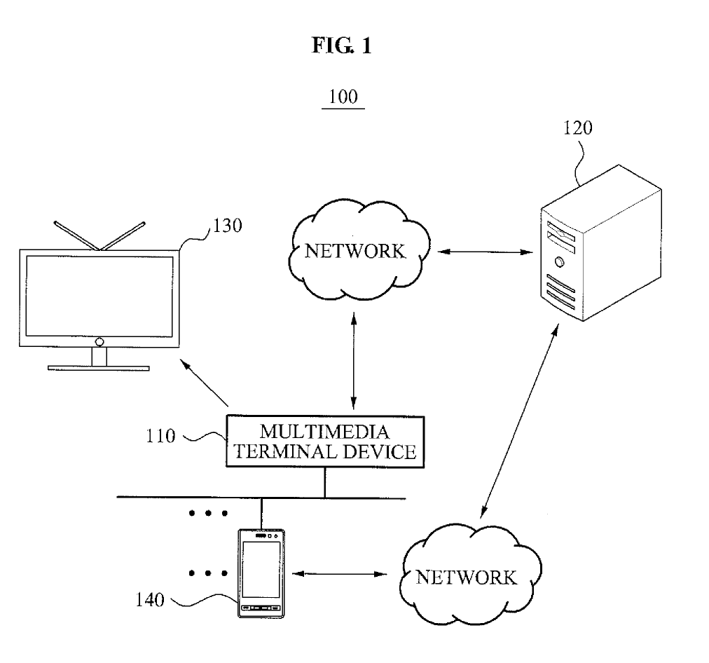

FIG. 1 is a diagram illustrating a bidirectional content service system 100 according to an embodiment of the present invention,

The bidirectional content service system 100 may include a multimedia terminal device 110, a content providing server 120, a display device 130, and a personal portable terminal 140.

The multimedia terminal device 110 may receive bidirectional content from the content providing server 120, and may display the received bidirectional content via the display device 130.

The bidirectional content described in the present invention may be defined as content to be provided, to a server, as feedback to an input of a user viewing content, and may be interpreted as Internet Protocol Television (IPTV) content, and the like.

Additionally, the content providing server 120 described in the present invention may include a content provider to provide bidirectional content, and an additional service information providing server to provide a user with information requested by the user via the content provider under the regular fee.

Furthermore, the multimedia terminal device 110 may be interpreted as a Set-Top Box (STB) installed in home, office, or public places. The display device 130 may be interpreted as a monitor connected to the STB. For example, the multimedia terminal device 110 and the display device 130 may be implemented in a single terminal.

While viewing the bidirectional content, a user may request additional service information corresponding to the bidirectional content. Such a user's request for the additional service information may be transferred to the content providing server 120 through the multimedia terminal device 110.

The content providing server 120 may include all servers or systems that may provide bidirectional content of multimedia type, for example a broadcasting system operated by a broadcasting provider, a communication and Internet system provided by a communication provider or Internet provider, and the like.

As an example, the content providing server 120 may transmit additional service information, as well as the bidirectional content, in response to the user's request.

As another example, the content providing server 120 may first transmit the additional service information together with the bidirectional content. When there is no user's request, the multimedia terminal device 110 may display only the bidirectional content via the display device 130.

As still another example, the content providing server 120 may receive the additional service information from another server, and may transmit the received additional service information to the multimedia terminal device 110.

When the bidirectional content and the additional service information are received together, the multimedia terminal device 110 may classify only the received additional service information, and may transmit the classified additional service information to the personal portable terminal 140 that is registered in advance.

The personal portable terminal 140 may receive detailed information regarding the bidirectional content via a heterogeneous network, using the additional service information.

The detailed information may be provided via the heterogeneous network, instead of the content providing server 120, unlike existing services, thereby reducing a load in a network. Additionally, various networks may be shared in a market, and thus it is possible to increase a Price Index (PI) of the market.

The personal portable terminal 140 may include all devices usable by only the user, and may be interpreted, for example, as a cellular phone, a Personal Digital Assistant (PDA), a smart phone, a tablet, a notebook computer, a Personal Computer (PC), and the like.

Accordingly, the multimedia terminal device 110 may register, in advance, the personal portable terminal 140, and may store and maintain terminal identification information of the personal portable terminal 140.

Additionally, for transmission, the multimedia terminal device 110 and the personal portable terminal 140 may be connected to each other via a local area wired/wireless communication, such as a Bluetooth.

As an example, the additional service information may be interpreted as detailed information regarding a predetermined object contained in bidirectional content, or link information used to view the detailed information.

As another example, the additional service information may be interpreted as Electronic Program Guide (EPG) information for IPTV content.

The multimedia terminal device 110 may display, on the display device 130, the bidirectional content, independently from the classified additional service information.

In other words, the multimedia terminal device 110 may provide the personal portable terminal 140 with the additional service information requested by the user, regardless of display of the bidirectional content.

Accordingly, when the multimedia terminal device 110 is used, when a user verifies additional service information received together with bidirectional content, a problem of covering a currently viewed screen may be prevented. Additionally, the user may verify desired additional service information using a user's own personal portable terminal, thereby preventing invasion of privacy from others.

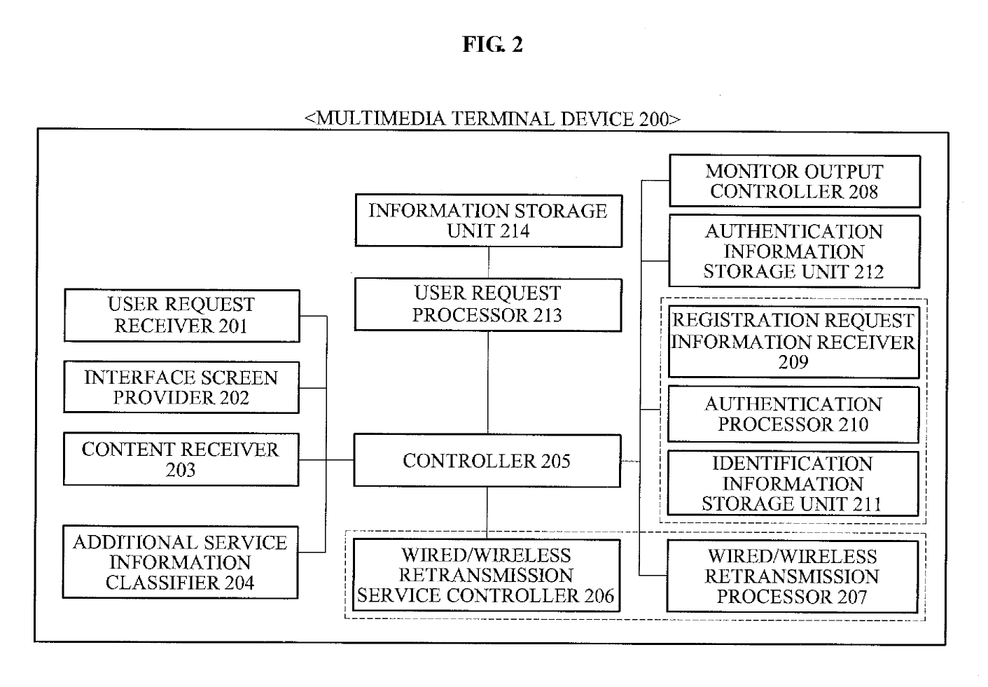

FIG. 2 is a block diagram illustrating a multimedia terminal device 200 according to an embodiment of the present invention.

The multimedia terminal device 200 of FIG. 2 may include a user request receiver 201, an interface screen provider 202, a content receiver 203, an additional service information classifier 204, a controller 205, a wired/wireless retransmission service controller 206, a wired/wireless retransmission processor 207, a monitor output controller 208, a registration request information receiver 209, an authentication processor 210, an identification information storage unit 211, an authentication information storage unit 212, a user request processor 213, and an information storage unit 214.

The user request receiver 201 may receive a selected request from a user viewing bidirectional content. The interface screen providing unit 202 may provide an interface screen used to request additional service information, in response to the received request.

The content receiver 203 may receive the bidirectional content, and may further receive the additional service information based on the request received from the user viewing the bidirectional content.

The additional service information classifier 204 may classify only the additional service information among the received bidirectional content and the received additional service information.

The controller 205 may function to perform operations that are required to receive the bidirectional content and to request and classify the additional service information. The controller 205 may control an overall operation of the multimedia terminal device 200.

A transmission controller including the wired/wireless retransmission service controller 206 and the wired/wireless retransmission processor 207 may transmit the classified additional service information to a personal portable terminal that is registered in advance.

Specifically, the wired/wireless retransmission service controller 206 may perform a series of processes required for wired/wireless retransmission of an additional service to a personal portable terminal. The wired/wireless retransmission processor 207 may actually transmit the additional service information to the personal portable terminal.

The additional service information may include at least one of detailed information, and link information that is used to view the detailed information.

For example, the additional service information may include information regarding a predetermined object contained in the bidirectional content.

More specifically, the bidirectional content may be interpreted as IPTV content for a predetermined program, and the additional service information may be interpreted as EPG information of the IPTV content.

Here, the detailed information in the additional service information may be interpreted as the EPG information, and the link information may be interpreted as link information used to view the EPG information.

Additionally, the link information may include a call connection to the outside, a text message transmission, a communication service including a messenger service, and the like.

In addition, the link information may be implemented in various forms, for example, meta data of an IPTV, an information tag, and the like.

The link information may be interpreted as address information for loading a web page of a predetermined server. Here, a user may select the link information transmitted to his or her personal portable terminal, and may access the web page, to view EPG information.

Additionally, the bidirectional content may be interpreted as shopping broadcasting content that is provided by a shopping mall server and that is used to advertise a predetermined product.

Here, the additional service information may be used as detailed information regarding the predetermined product, and may include, for example, information regarding a selling place, an amount of sales, a pay-in account, detailed description, and the like. Additionally, the additional service information may include only link information regarding a web page through which a user is able to view the detailed information.

In other words, the additional service information may also be interpreted as link information including at least one of a callback number and a callback Uniform Resource Locator (URL) that are used to identify the detailed information regarding the bidirectional content.

In addition, the additional service information may be interpreted as object information regarding a predetermined object appearing in currently viewed bidirectional content, for example, information on a product such as clothes, furniture, and the like, or detailed information regarding a predetermined actor in the currently viewed bidirectional content.

According to an embodiment of the present invention, only brief information corresponding to additional service information requested by a user may be received from a server and thus, it is possible to efficiently use a transmission bandwidth.

The monitor output controller 208 may control at least one of received bidirectional content and received additional service information to be displayed on a monitor, namely a display device.

The multimedia terminal device 200 may register a personal portable terminal, in order to transmit additional service information.

Accordingly, the multimedia terminal device 200 may further include the registration request information receiver 209, the authentication processor 210, and the identification information storage unit 211.

The registration request information receiver 209 may receive registration request information from a personal portable terminal requesting a registration. The authentication processor 210 may process an authentication of the personal portable terminal, based on the registration request information.

Additionally, the identification information storage unit 211 may store terminal identification information of the personal portable terminal requesting the registration.

For example, the registration request information may include telephone information of the personal portable terminal. Here, the registration request information receiver 209 may receive the registration request information including the telephone information, so that the registration may be requested.

Subsequently, the authentication processor 210 may determine whether the telephone information is available, and may process the authentication of the personal portable terminal.

The identification information storage unit 211 may store and maintain the telephone information as the terminal identification information in a predetermined storage medium.

The terminal identification information may be interpreted as an Electronic Serial Number (ESN) of the personal portable terminal, as well as the telephone information.

The authentication information storage unit 212 may store authentication information corresponding to the personal portable terminal.

The authentication processor 210 may authenticate an availability of the personal portable terminal during initial registration. The authentication information stored in the authentication information storage unit 212 may be interpreted as a password number input by a personal portable terminal, prior to transmitting of additional service information.

Specifically, when additional service information to be transmitted exists in a personal portable terminal, the multimedia terminal device 200 may request the personal portable terminal to transmit authentication information.

The multimedia terminal device 200 may compare the authentication information received from the personal portable terminal with the authentication information stored in the authentication information storage unit 212. When the received authentication information from the personal portable terminal corresponds to the authentication information stored in the authentication information storage unit 212, the multimedia terminal device 200 may transmit the additional service information to the personal portable terminal.

For example, by the authentication information storage unit 212, it is possible to prevent minors from accessing information regarding some risk factors, for example adult-related products, drugs requiring careful handling, and the like.

The user request processor 213 may request a content providing server to execute a requested additional service, in response to a user's request to provide additional service information.

The information storage unit 214 may store content-related information that is received in advance from the content providing server.

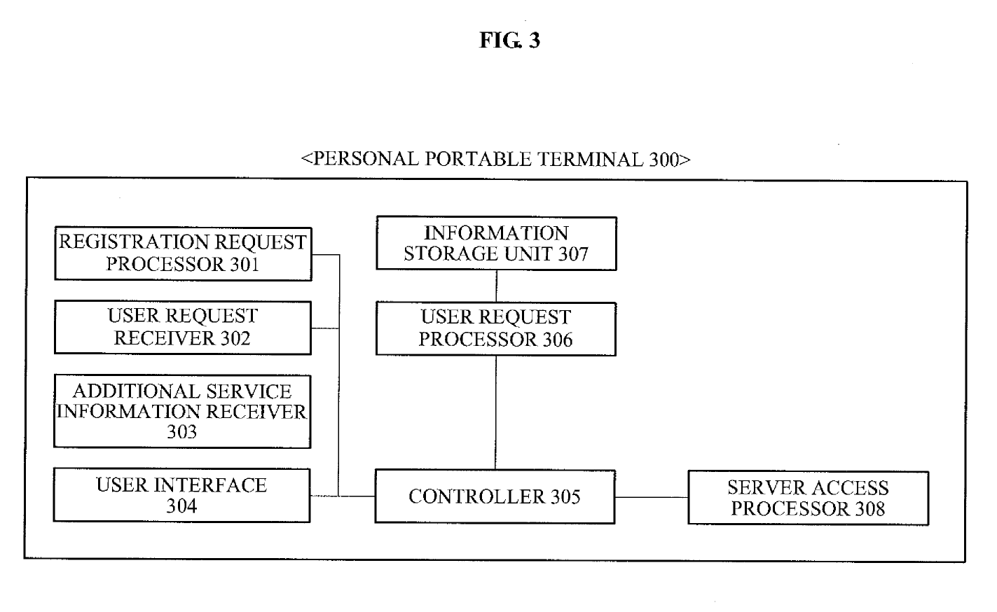

FIG. 3 is a block diagram illustrating a personal portable terminal 300 according to an embodiment of the present invention.

The personal portable terminal 300 of FIG. 3 may include a registration request processor 301, a user request receiver 302, an additional service information receiver 303, a user interface 304, a controller 305, a user request processor 306, an information storage unit 307, and a server access processor 308.

The registration request processor 301 may request a multimedia terminal device to register the personal portable terminal 300, in order to receive additional service information from the multimedia terminal device.

In other words, the registration request processor 301 may send a registration request to the multimedia terminal device that receives, from a content providing server, bidirectional content and additional service information corresponding to the bidirectional content.

For example, the registration request processor 301 may transmit terminal identification information and authentication information to the multimedia terminal device, to request the registration.

When provided additional service information is requested via a wired/wireless heterogeneous network supported by the personal portable terminal 300, after the registration in the multimedia terminal device, the user request receiver 302 may request receiving of the additional service information via a wired/wireless heterogeneous network supported by the user request receiver 302, similarly to a mobile communication network.

Since a personal portable terminal typically supports a mobile communication network or a Wireless Fidelity (Wi-Fi) network, the mobile communication network or the Wi-Fi network may be used, however there is no limitation thereto. Accordingly, a wired/wireless heterogeneous network enabling connection of a personal portable terminal, a content provider, an information provider or the like may also be applied.

The personal portable terminal 300 may receive an additional service directly from a content provider, or may receive an additional service through an information provider that is connected to the content provider.

The additional service information receiver 303 may receive the additional service information from the multimedia terminal device, after the registration in the multimedia terminal device.

When a user of the personal portable terminal 300 requests additional service information using a wired/wireless heterogeneous network such as a local area communication network, instead of using a mobile communication network, the user interface 304 may provide an interface screen associated with providing of the additional service information.

The controller 305 may control each of the above-described components in the personal portable terminal 300, and may perform a series of processes associated with a wired/wireless retransmission service to the personal portable terminal 300.

In response to a request of the user for additional service information, the user request processor 306 may process a request to view the requested additional service information to be transmitted to the content provider or the information provider via the wired/wireless heterogeneous network.

The information storage unit 307 may store pieces of information associated with bidirectional content of multimedia type that is received in advance from the multimedia terminal device.

Here, the additional service information may include a callback URL used to identify detailed information regarding the bidirectional content. The server access processor 308 may access a server using the callback URL.

Specifically, the server access processor 308 may access a server connected to a heterogeneous network using the callback URL, and may receive the detailed information via the heterogeneous network from the accessed server.

The personal portable terminal 300 may be connected wired or wirelessly to the multimedia terminal device.

For example, when a multimedia terminal device, such as a TV STB or a Digital Video Recorder (DVR), supports an interface enabling wired or wireless connection to the personal portable terminal 300, the multimedia terminal device may be connected to the personal portable terminal 300, directly, instead of using a display device.

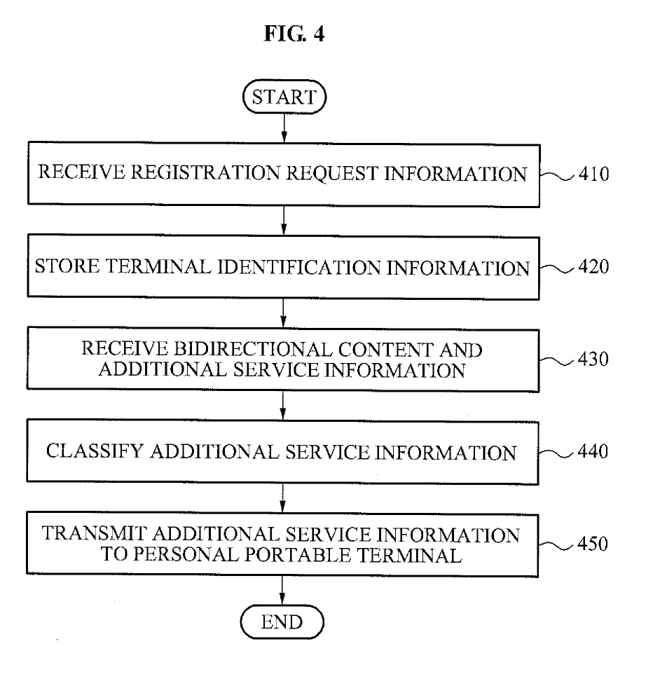

FIG. 4 is a flowchart illustrating an operating method of a multimedia terminal device according to an embodiment of the present invention.

In operation 410, registration request information may be received from a personal portable terminal that requests a registration. In operation 420, terminal identification information of the personal portable terminal may be stored.

For example, the terminal identification information may be interpreted as phone number information of the personal portable terminal. Here, the registration request information may include the phone number information, and a multimedia terminal device receiving the registration request information may store and maintain the phone number information in a predetermined storage medium.

An availability of the personal portable terminal may be authenticated.

In operation 430, bidirectional content, and additional service information corresponding to the bidirectional content may be received.

The additional service information may include either detailed information, or link information used to view the detailed information.

In operation 440, the received additional service information may be classified from the received bidirectional content.

In operation 450, the classified additional service information may be transmitted to the personal portable terminal, based on the stored terminal identification information.

Here, the terminal identification information may be used to transmit the classified additional service information to the personal portable terminal.

Prior to the transmitting of the additional service information, an existence of additional service information to be transmitted may be reported to the personal portable terminal, and authentication information may be received from the personal portable terminal, to determine whether to transmit the additional service information.

Accordingly, the authentication information may be received in advance from a user, and the received authentication information may be stored in the storage medium.

In other words, to store authentication information corresponding to the personal portable terminal and to transmit the classified additional service information to the personal portable terminal, whether the authentication information received from the personal portable terminal corresponds to the stored authentication information may be determined. When the received authentication information is determined to correspond to the stored authentication information, the additional service information may be transmitted to the personal portable terminal.

The operating method of the multimedia terminal device according to the embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

According to embodiments of the present invention, it is possible to prevent additional service information received together with bidirectional content from covering a currently viewed screen, when a user verifies the additional service information.

Additionally, according to embodiments of the present invention, a user may verify desired additional service information using a user's own personal portable terminal and thus, it is possible to prevent invasion of privacy from others.

Furthermore, according to embodiments of the present invention, it is possible to efficiently use a transmission bandwidth, by receiving only brief information corresponding to additional service information requested by a user.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A multimedia terminal device, comprising:
a content receiver to receive bidirectional content, and additional service information corresponding to the bidirectional content;
an additional service information classifier to classify the received additional service information from the received bidirectional content; and
a transmission controller to transmit the classified additional service information to a personal portable terminal, registered in advance,
wherein the personal portable terminal receives detailed information regarding the to bidirectional content via a heterogeneous network, using the additional service information.

2. The multimedia terminal device of claim 1, wherein the additional service information is link information comprising at least one of a callback number and a callback Uniform Resource Locator (URL) that are used to identify the detailed information regarding the bidirectional content, and
wherein the transmission controller transmits the link information as the additional service information to the personal portable terminal.

3. The multimedia terminal device of claim 1, further comprising:
a registration request information receiver to receive registration request information from a personal portable terminal requesting a registration; and
an identification information storage unit to store terminal identification information of the personal portable terminal requesting the registration,
wherein the transmission controller transmits the classified additional service information based on the stored terminal identification information.

4. The multimedia terminal device of claim 3, further comprising:
an authentication processor to process an authentication of the personal portable terminal requesting the registration.

5. The multimedia terminal device of claim 1, further comprising:
an authentication information storage unit to store authentication information corresponding to the personal portable terminal,
wherein the transmission controller determines whether authentication information received from the personal portable terminal corresponds to the stored authentication information, and transmits the additional service information.

6. The multimedia terminal device of claim 1, wherein the additional service information comprises at least one of detailed information of an object included in the bidirectional content and Electronic Program Guide (EPG) information of the bidirectional content.

7. A personal portable terminal, comprising:
a registration request processor to request a multimedia terminal device to register the personal portable terminal, the multimedia terminal device receiving bidirectional content, and additional service information corresponding to the bidirectional content from a content providing server;
an additional service information receiver to receive the additional service information from the multimedia terminal device when the personal portable terminal is registered in the multimedia terminal device; and
a user interface to display the received additional service information,

8. The personal portable terminal of claim 7, further comprising:
a server access processor to access a server connected to a heterogeneous network using a callback Uniform Resource Locator (URL), and to receive detailed information regarding the bidirectional content via the heterogeneous network from the server, the callback URL being used to identify the detailed information,
wherein the additional service information comprises the callback URL.

9. The personal portable terminal of claim 7, wherein the registration request processor transmits terminal identification information and authentication information to the multimedia terminal device, and requests a registration of the personal portable terminal.

10. An operating method of a multimedia terminal device, the operating method comprising:
receiving registration request information from a personal portable terminal requesting a registration;
storing terminal identification information of the personal portable terminal requesting the registration;
receiving bidirectional content and additional service information corresponding to the bidirectional content;
classifying the received additional service information from the received bidirectional content; and
transmitting the classified additional service information to the personal portable terminal requesting the registration, based on the stored terminal identification information.

11. The operating method of claim 10, further comprising:
processing an authentication of the personal portable terminal requesting the registration.

12. The operating method of claim 10, further comprising:
storing authentication information corresponding to the personal portable terminal, wherein the transmitting comprises:
determining whether authentication information received from the personal portable terminal corresponds to the stored authentication information; and
transmitting the additional service information to the personal portable terminal when the received authentication information is determined to correspond to the stored authentication information.
